(19) United States
(12) Patent Application Publication
(10) Pub. No.: US 2025/0091535 A1
(43) Pub. Date: Mar. 20, 2025

(54) PUSH-TYPE CHARGING INTERCONNECTION STRUCTURE AND PUSH-TYPE CHARGING INTERCONNECTION SYSTEM FOR DETACHABLE SPEAKER

(71) Applicant: Tymphany HK Limited, Hong Kong (HK)

(72) Inventors: YIKAI GUO, Taipei City (TW); TIANBAO XIE, Taipei City (TW); KAIJIU TAN, Taipei City (TW)

(21) Appl. No.: 18/886,351

(22) Filed: Sep. 16, 2024

Related U.S. Application Data
(60) Provisional application No. 63/583,728, filed on Sep. 19, 2023.

(51) Int. Cl. B60R 16/03; B60R 11/00; B60R 11/02; H01R 13/629; H04R 1/02

(52) U.S. Cl. CPC B60R 16/03; B60R 11/0217; H01R 13/629; H04R 1/026; B60R 2011/0075

(57) ABSTRACT

A push-type charging interconnection structure includes a base, an abutting block, a wire fixing plate body, and an elastic element. The abutting block is movably located at the front side of the base. The wire fixing plate body is rotatably located at the bottom of the base. One end of the elastic element is fixed to the base and the other end of the elastic element is fixed to the wire fixing plate body. When the abutting block is pressed it moves toward the base such that the abutting block abuts against the wire fixing plate body and drives the wire fixing plate body to rotate toward the abutting block. When the abutting block moves away from the base the wire fixing plate body is pulled downward by the tension of the elastic element and rotates away from the abutting block.

### CROSS REFERENCE TO RELATED APPLICATIONS

This application claims priority of U.S. Provisional Application No. 63/583,728 filed on Sep. 19, 2023 under 35 U.S.C. § 119(e), the entire contents of which are hereby incorporated by reference.

### BACKGROUND OF THE INVENTION

The present invention relates to a speaker structure, particularly to a push-type charging interconnection structure for a vehicle-mounted detachable speaker and a push-type charging interconnection system for a detachable speaker.

### DESCRIPTION OF THE PRIOR ART

Existing car speakers mainly include fixed, movable, and plug-in types.

Fixed car speakers are installed inside the vehicle and cannot be separated from the vehicle body or moved within it, and they are powered by wiring harnesses.

Movable car speakers can be rotated or popped out of the dashboard, but the car speakers cannot be separated from the vehicle body and are powered by wiring harnesses.

Plug-in car speakers are separately purchased by users and powered by being plugged into an electrical outlet within the speaker system, and they may lack a stable fixed method.

However, existing car speakers require power through internal wiring harnesses or charging by plugging and unplugging power cables. Additionally, their use is inconvenient due to being fixed inside the car, and the presence of power cables in the central control area can create safety hazards.

Therefore, there is a need for further improved solutions in the current technology.

### SUMMARY OF THE INVENTION

In view of the shortcomings of the abovementioned prior art, an objective of the present invention is to provide a push-type charging interconnection structure and a push-type charging interconnection system for a detachable speaker. By incorporating an abutting block and an elastic element, the speaker can be more easily inserted and removed from the push-type charging interconnection structure, thereby enhancing safety and user convenience.

To achieve the abovementioned objective, the present invention primarily employs the following technical means, specifically allowing the push-type charging interconnection structure to include a base; an abutting block, located movably forward and backward on a front side of the base; a wire fixing plate body, disposed rotatably at a bottom of the base; and an elastic element, wherein one end of the elastic element is fixed to the base and the other end of the elastic element is fixed to the wire fixing plate body.

In an exemplary embodiment, the base includes a groove; a hole, penetrating through the groove from a front side of the groove to a rear side of the groove; a sheet body, located close to a top of the hole and extending forward from a front side of the groove and away from the groove; a fixing element, extending from a bottom surface of the sheet body and away from the sheet body; and a bottom plate, extending downward form a bottom of the groove.

In an exemplary embodiment, the fixing element includes a fixing main body, extending from the bottom surface of the sheet body and away from the sheet body; and

a stopper, set parallel to the sheet body, wherein the stopper is located at a bottom of the fixing element.

In an exemplary embodiment, the abutting block includes a plate body;

a convex element, respectively extending from a top and a bottom of the plate body and away from the plate body, wherein the convex element extends forward and bends outward and extends arcuately, and the convex element also bends inward and extends in a direction of an extension line at two ends of the plate body; a combining element, protruding from a rear side of the convex element in a direction away from the convex element; and an abutting element, protruding from the rear side of the convex element close to the bottom of the plate body in the direction away from the convex element.

In an exemplary embodiment, the wire fixing plate body includes a bending part; a through hole, penetrating from a front side of the bending part to a rear side of the bending part, wherein the through hole is located close to a top of the bending part; an arc part, extending downward obliquely from a bottom of the bending part, wherein the arc part extends forward arcuately and away from the bottom of the bending part; and a cylinder combining element, located on an outer side close to the bottom of the bending part, wherein the cylinder combining element extends outward from the outer side of the bending part.

In an exemplary embodiment, the hole includes a first hole, extending from the top of the hole toward the bottom of the groove, and a second hole, extending from a bottom of the first hole toward the bottom of the groove and flaring toward two opposite side walls of the groove.

In an exemplary embodiment, the elastic element passes through the first hole, and the abutting element passes through the second hole.

In an exemplary embodiment, the fixing element extends gradually inward from the bottom surface of the sheet body in a direction away from the sheet body.

In an exemplary embodiment, the bottom plate includes a notch, recessed from a portion of a bottom of the bottom plate in the direction of the groove; and a first semicircular groove, located on a rear side of the bottom plate, wherein the first semicircular groove is located on two opposite sides of the notch and the first semicircular groove extends outward in a direction away from the notch.

In an exemplary embodiment, the push-type charging interconnection structure further includes a fixing part, located on an opposite side of the bottom plate.

In an exemplary embodiment, the fixing part includes a fixing plate body; a second semicircular groove, recessed from a front side of the fixing plate body to a rear side of the fixing plate body, wherein two ends of the second semicircular groove are respectively located on two side surfaces of the fixing plate body; a position limiting sheet body, extending from one end of the second semicircular groove toward the front side of the fixing plate body; and

a fixing hole, located close to a top and a bottom of the fixing plate body.

Via the abovementioned structure, when the abutting block is pressed, the abutting block moves toward the base, causing the abutting block to abut against the wire fixing plate body and drive the wire fixing plate body to rotate in the direction of the abutting block and when the abutting block moves away from the base, the wire fixing plate body is pulled by the elastic element and rotates downward and away from the abutting block.

To achieve the abovementioned object, another primary technical means adopted by the present invention is to provide a push-type charging interconnection system for a detachable speaker, which includes a speaker body; and a push-type charging interconnection structure as described above; wherein the speaker body is movably located on a front side of the push-type charging interconnection structure; when the speaker body moves toward the push-type charging interconnection structure, the wire fixing plate body of the push-type charging interconnection structure is driven to rotate toward the speaker body; when the speaker body moves away from the push-type charging interconnection structure, the wire fixing plate body of the push-type charging interconnection structure is pulled by the elastic element to rotate downward and away from the speaker body.

In an exemplary embodiment, when the speaker body moves toward the push-type charging interconnection structure, the wire fixing plate body drives the charging element such that the charging element engages with the charging interface inside the speaker body.

Via the abovementioned structure, when the speaker body moves toward the push-type charging interconnection structure, the wire fixing plate body of the push-type charging interconnection structure is driven to rotate toward the speaker body and when the speaker body moves away from the push-type charging interconnection structure, the wire fixing plate body of the push-type charging interconnection structure is pulled downward and away from the speaker body by the elastic element.

### BRIEF DESCRIPTION OF DRAWINGS

The accompanying drawings described here are provided to offer further understanding of the present invention, forming a part of the present invention. The schematic embodiments of the present invention and their descriptions are used to explain the present invention and do not constitute undue limitations on the present invention. In the drawings:

FIG. 1 is a sectional view of the push-type charging interconnection system for a detachable speaker in a separating state according to the present invention.

FIG. 2 is a sectional view of the push-type charging interconnection system for a detachable speaker in a combining state according to the present invention.

FIG. 3 is a sectional view of the push-type charging interconnection structure according to the present invention.

FIG. 4 is a front view of the base according to the present invention.

FIG. 5 is a rear view of the base according to the present invention.

FIG. 6 is an enlarged view of area C in FIG. 4.

FIG. 7 is a perspective view of the abutting block according to the present invention.

FIG. 8 is a perspective view of the fixing part according to the present invention.

FIG. 9 is an enlarged view of area A in FIG. 1.

FIG. 10 is an enlarged view of area B in FIG. 2.

### DETAILED DESCRIPTION

Below, in conjunction with the drawings from the embodiments of the present invention, the technical solutions of the embodiments will be clearly and fully described. It is evident that the described embodiments are part of the present invention and not all of them. Based on the embodiments of the present invention, any other embodiments that a person of ordinary skill in the art could obtain without creative effort are within the scope of protection of the present invention.

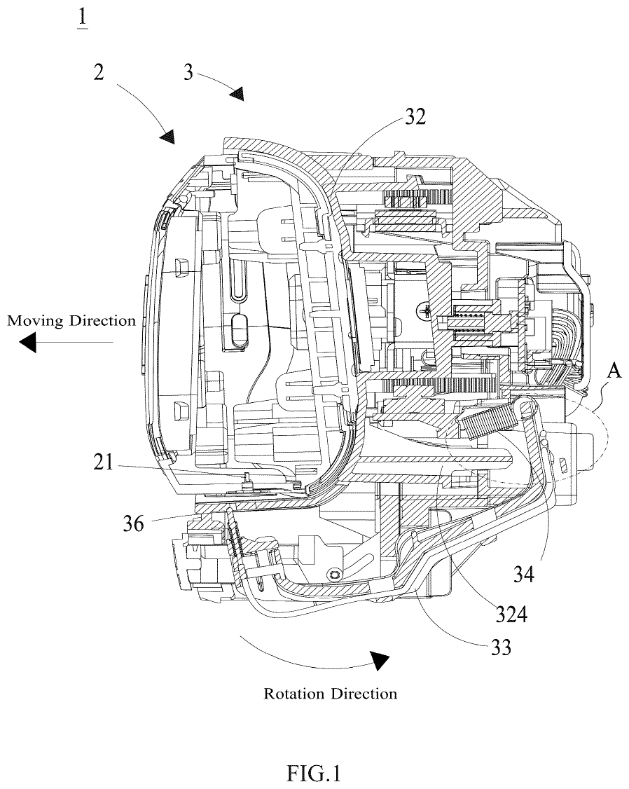

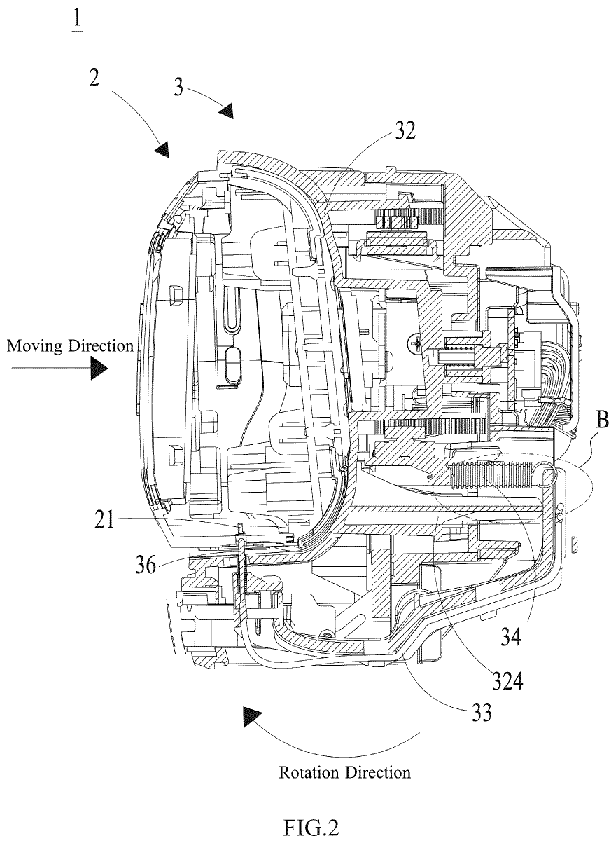

FIG. 1 is a sectional view of the push-type charging interconnection system for a detachable speaker in a separating state according to the present invention, FIG. 2 is a sectional view of the push-type charging interconnection system for a detachable speaker in a combining state according to the present invention, and FIG. 1 and FIG. 2 respectively show a sectional view along the direction of the push-type charging interconnection structure from the speaker body. As shown in FIG. 1 and FIG. 2, the push-type charging interconnection system for a detachable speaker 1 according to the present invention includes a speaker body 2 and a push-type charging interconnection structure 3. The speaker body 2 is movably located on the front side of the push-type charging interconnection structure 3. When the speaker body 2 moves toward the push-type charging interconnection structure 3, the speaker body 2 will drive the abutting block 32 of the push-type charging interconnection structure 3 to abut against the wire fixing plate body 33, specifically an abutting element 324 of the abutting block 32 will press against the wire fixing plate body 33, causing the wire fixing plate body 33 of the push-type charging interconnection structure 3 to rotate upward such that the charging element 36 engages with the charging interface 21 inside the speaker body 2, enabling power transmission to the speaker body 2. When the speaker body 2 moves away from the push-type charging interconnection structure 3, the wire fixing plate body 33 of the push-type charging interconnection structure 3 is no longer abutted by the abutting element 324, and the elastic element 34 of the push-type charging interconnection structure 3 exerts a pulling force on the charging structure of the push-type charging interconnection structure 3, causing the wire fixing plate body 33 of the push-type charging interconnection structure 3 to rotate downward and disengage from the speaker body 2. In this embodiment, the push-type charging interconnection system for a detachable speaker 1 is intended for in-car use. The push-type charging interconnection structure 3 can be embedded and installed in an appropriate location within the car body, such as being fixedly mounted on a flat area of the dashboard of the car, embedded in a car seat, or disposed in the car's central control area.

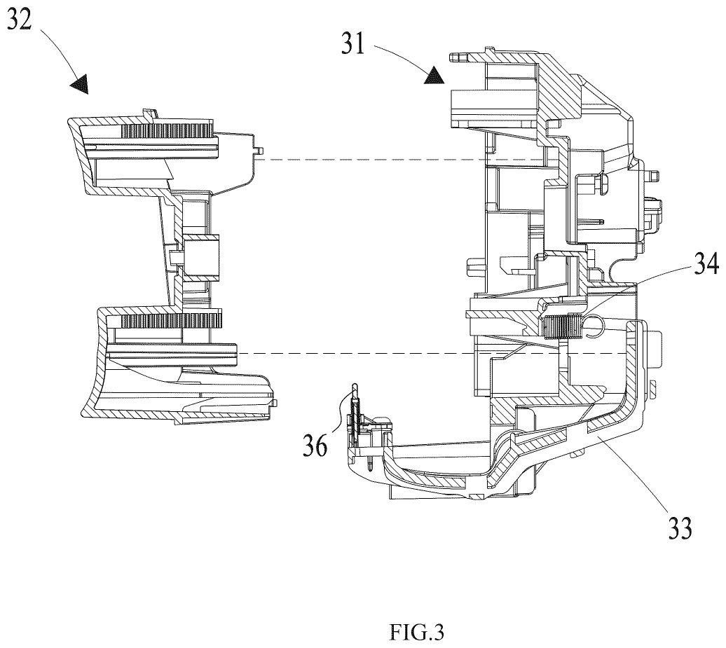

FIG. 3 is a sectional view of the push-type charging interconnection structure according to the present invention. As shown in FIG. 3, the push-type charging interconnection structure 3 includes a base 31, an abutting block 32, a wire fixing plate body 33, and an elastic element 34. The abutting block 32 is movably disposed on the front side of the base 31. The wire fixing plate body 33 is rotatably mounted at the bottom of the base 31. One end of the elastic element 34 is fixed to the base 31, and the other end is fixed to the wire fixing plate body 33. When the abutting block 32 is pushed inward by the speaker body 2 and abuts against the wire fixing plate body 33, the contact will cause the wire fixing plate body 33 to rotate in the direction of the abutting block 32, i.e., in a clockwise direction, and the wire fixing plate body 33 will drive the charging element 36 such that the charging element 36 engages with the charging interface 21 inside the speaker body 2. When the abutting block 32 does not abut against the wire fixing plate body 33, the restoring force of the elastic element 34 will cause the wire fixing plate body 33 to rotate away from the abutting block 32, i.e., in a counterclockwise direction.

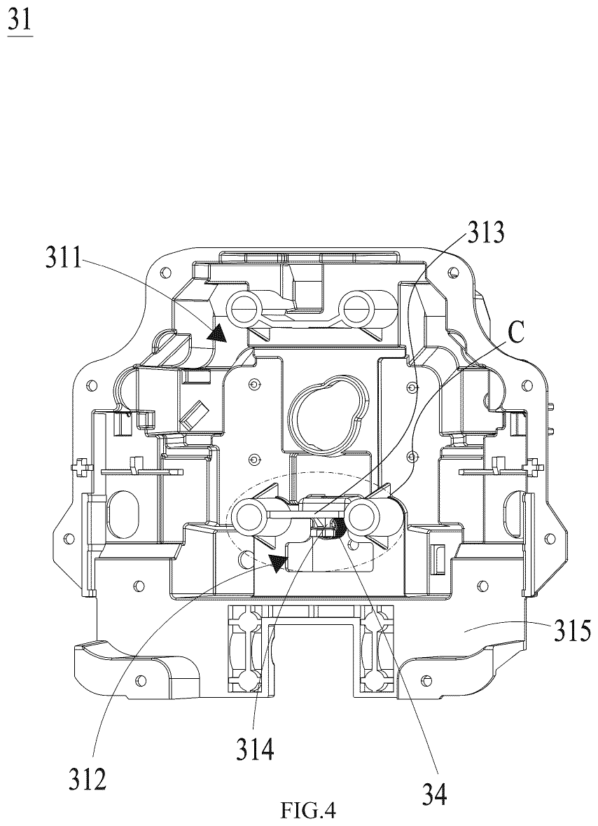

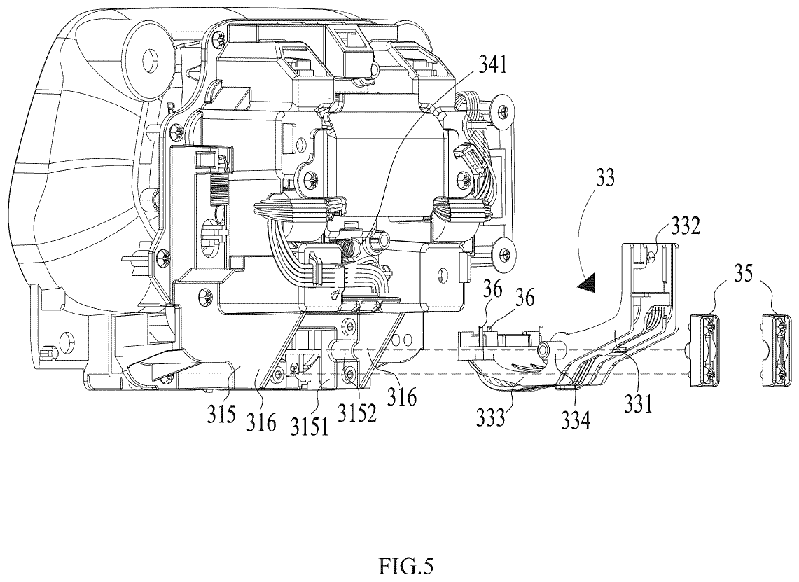

FIG. 4 is a front view of the base 31 according to certain exemplary embodiments of the present invention, and FIG. 5 is a rear view of the base 31 according to certain exemplary embodiments of the present invention. As shown in FIG. 4 and FIG. 5, the base 31 includes a groove 311, a hole 312, a sheet body 313, a fixing element 314, a bottom plate 315, and a side plate 316. The hole 312 penetrates through the groove 311 from the front side of the groove 311 to the rear side of the groove 311. The sheet body 313 is located close to the top of the hole 312 and extends forward from the front side of the groove 311 and away from the groove 311. The fixing element 314 extends from the bottom surface of the sheet body 313 in a direction away from the sheet body 313. The bottom plate 315 extends downward from the bottom of the groove 311. In this embodiment, when the elastic element 34 passes through the hole 312 from the rear side of the groove 311, one end of the elastic element 34 is fixed to the fixing element 314. In this embodiment, one end of the elastic element 34 forms a hook 341.

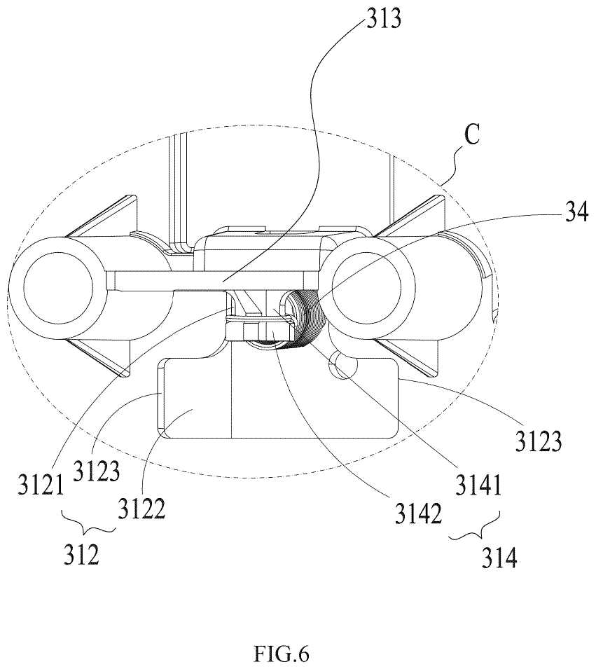

FIG. 6 is an enlarged view of area C in FIG. 4. Referring to FIG. 4, FIG. 5, and FIG. 6, the of the hole 312 extends toward the bottom of the groove 311 to form the first hole 3121. Then, from the bottom of the first hole 3121, it continues to extend toward the bottom of the groove 311, flaring along the two opposite side walls 3123 of the groove 311, to form the second hole 3122. The elastic element 34 passes through the first hole and is fixed to the fixing element 314. In this embodiment, the fixing element 314 includes a fixing main body 3141 and a stopper 3142. The fixing main body 3141 extends inwardly, inclined from the bottom surface of the sheet body 313, and away from the sheet body 313. A stopper 3142 is located at the bottom of the fixing main body 3141, and the stopper 3142 is set parallel to the sheet body 313. The stopper 3142 is located at the bottom of the fixing main body 3141 to prevent the elastic element 34 from slipping down and becoming unhooked when one end of the elastic element 34 is located on the fixing main body 3141. As shown in FIG. 5, the bottom plate 315 includes a notch 3151 and a first semicircular groove 3152. The notch 3151 is recessed from a portion of the bottom of the bottom plate 316 toward the groove 311, the first semicircular groove 3152 is located on the rear side of the bottom plate 315 and on the two opposite sides of the notch 3151. The first semicircular groove 3152 is formed via recessing from the rear side of the bottom plate 315, and the first semicircular groove 3152 extends outward away from the notch 3151 such that the inner end of the first semicircular groove 3152 is adjacent to the notch 3151. The side plate 316 is located at the outer end of the first semicircular groove 3152 (i.e., away from the notch) to close the outer end of the first semicircular groove 3152. The side plate 316 extends from the rear side of the bottom plate 315 and in a direction away from the bottom plate 315. In this embodiment, the fixing main body 3141 is a plurality of ribs, and each of the ribs is arranged perpendicularly adjacent to one another. The stopper 3142 also is a plurality of ribs, and each of the ribs is located perpendicularly adjacent to one another, and each of the ribs of the stopper 3142 corresponds one-to-one with each of the ribs of the fixing element 314. In some embodiments, the stopper 3142 and the fixing main body 3141 are integrally formed. There are two first semicircular grooves 3152, and the two first semicircular grooves 3152 are located on the two opposite sides of the notch 3151. There are two side plates 316, and the two side plates 316 are located correspondingly at the outer ends of the two first semicircular grooves 3152.

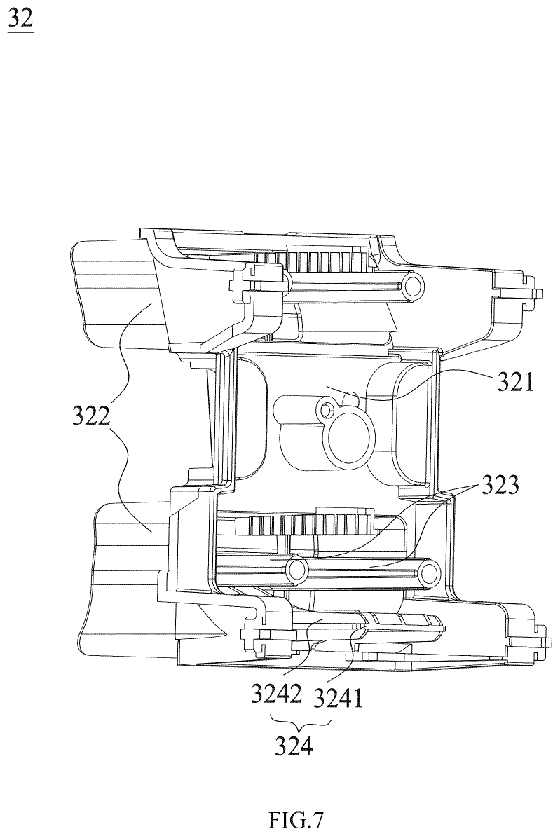

FIG. 7 is a perspective view of the abutting block of the present invention. As shown in FIG. 7, the abutting block 32 includes a plate body 321, a convex element 322, a combining element 323, and an abutting element 324. The convex element 322 respectively extends forward from the top and bottom of the plate body 321 in a direction away from the plate body 321, and then the convex element 322 bends outward and extends arcuately. Furthermore, the convex element 322 bends inward and extends in the direction of the extension line at two ends of the plate body 321. Thus, an opening is formed between the two ends of the convex element 322. The combining element 323 protrudes from the rear side of the convex element 322 and away from the convex element 322. The abutting element 324 protrudes from the rear side of the convex element 322 close to the bottom of the plate body 321, in the direction away from the convex element 322, and the abutting element 32 is located under the elastic element 34. The abutting element 324 passes through the second hole 3122 to abut against the wire fixing plate body 33. Specifically, the convex element 322 is shaped as a U-shape, and the opening of the U-shape faces the base 31. The combining element 323 and the abutting element 324 respectively protrude from the opposite sides of the U-shaped opening in the direction away from the convex element 322. The abutting element 324 includes an abutting plate body 3241 and a plurality of ribs 3242. Each rib 3242 respectively extends from the top and bottom surfaces of the abutting plate body 3241 in the direction away from the abutting plate body 3241, and the ribs 3242 are spaced apart from one another. When the speaker body 2 engages, the speaker body 2 will contact the convex element 322 and push the convex element 322 inward such that the abutting plate body 3241 abuts against the wire fixing plate body 33.

As shown in FIG. 5, the wire fixing plate body 33 includes a bending part 331, a through hole 332, an arc part 333, and a cylinder combining element 334. The through hole 332 penetrates from a front side of the bending part 331 to the rear side of the bending part 331, the through hole 332 is located close to the top of the bending part 331, and the through hole 332 is used for hooking the hook 341 of the elastic element 34. The arc part 333 extends downwardly at an incline from the bottom of the bending part 331, and then the arc part 333 extends forward arcuately and away from the bottom of the bending part 331. The cylinder combining element 334 is located on the outer side close to the bottom of the bending part 331, and the cylinder combining element 334 extends outwardly from the outer side of the bending part 331. The cylinder combining element 334 is rotatably disposed in the first semicircular groove 3152. In this embodiment, the cylinder combining element 334 is cylindrical.

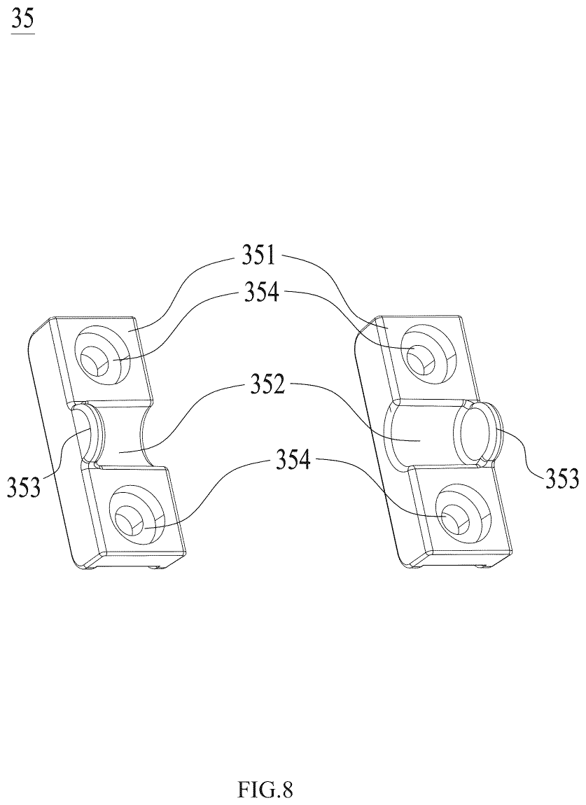

FIG. 8 is a perspective view of the fixing part of the present invention. As shown in FIG. 5 and FIG. 8, in some embodiments, the push-type charging interconnection structure 3 further includes a fixing part 35. The fixing part 35 is located on the opposite side of the bottom plate 315 when the cylinder combining element 334 is located in the first semicircular groove 3152, such that the fixing part 35 can fix the cylinder combining element 334 toward the bottom plate 315 to prevent the cylinder combining element 334 from falling out during rotation. Specifically, the fixing part 35 includes a fixing plate body 351, a second semicircular groove 352, a position limiting sheet body 353, and a fixing hole 354. The second semicircular groove 352 is recessed from the front side of the fixing plate body 351 toward the rear side of the fixing plate body 351, and the two ends of the second semicircular groove 352 are respectively located on the two sides of the fixing plate body 351. The position limiting sheet body 353 extends from one end of the second semicircular groove 352 toward the front side of the fixing plate body 351 to correspondingly close off one end of the second semicircular groove 352. The fixing hole 354 is located close to the top and bottom of the fixing plate body 351, meaning that the fixing hole 354 is located on two sides of the second semicircular groove 352 and the fixing hole 354 penetrates through the front side and rear side of the fixing plate body 351. The fixing hole 354 is designed for screwing a fastener. In this embodiment, the position limiting sheet body 353 is circular, allowing a portion of the semicircle of the position limiting sheet body 353 to close off one end of the second semicircular groove, and the other portion of the semicircle of the position limiting sheet body 353 is exposed on the front side of the fixing plate body 351 for integration with the first semicircular groove 3152. When the fixing part 35 abuts against one side of the cylinder combining element 334, the position limiting sheet body 353 will contact the outer end of the cylinder combining element 334. In this embodiment, there are two fixing holes 354.

In some embodiments, (e.g., as illustrated in FIG. 5) the push-type charging interconnection structure 3 further includes a charging element 36. The charging element 36 is located at the end of the wire fixing plate body 33 that is away from the through hole 332, and the wiring of the charging element 36 is laid along the bending part 331 and the arc part 333.

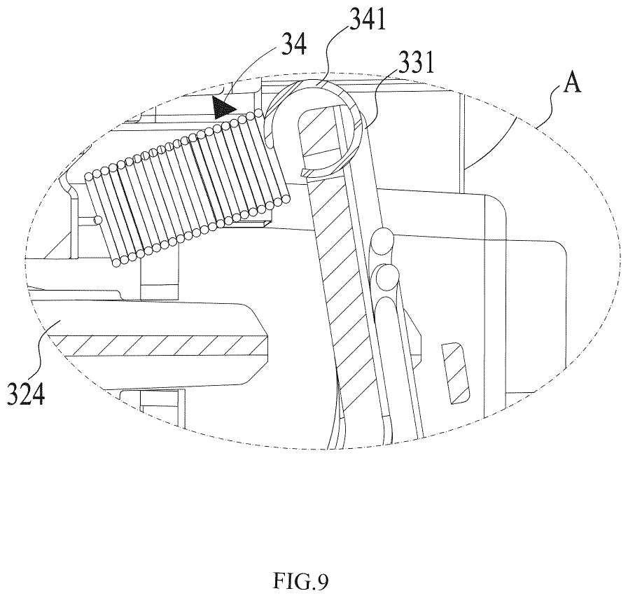

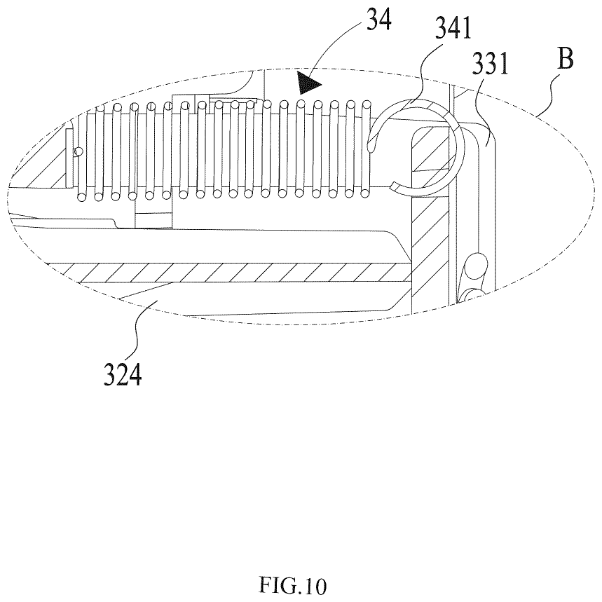

FIG. 9 is an enlarged view of area A in FIG. 1, and FIG. 10 is an enlarged view of area B in FIG. 2. As shown in FIG. 9, when the abutting element 324 does not abut against the bending part 331 of the wire fixing plate body 33, the elastic element 34 will generate a pulling force due to the restoring force of the elastic element 34 such that the wire fixing plate body 33 is pulled back via the elastic element 34 and the wire fixing plate body 33 rotates in a counterclockwise direction. As shown in FIG. 10, when the abutting element 324 abuts against the bending part 331, the elastic element 34 will generate tension due to the restoring force of the elastic element 34, causing the wire fixing plate body 33 to be pushed to rotate in a clockwise direction.

In summary, through the abovementioned push-type charging interconnection system for a detachable speaker, when the speaker body moves toward the push-type charging interconnection structure (i.e., the speaker body is fitted onto the vehicle dashboard), it will drive the wire fixing plate body of the push-type charging interconnection structure to rotate in the direction toward the speaker body. When the speaker body moves away from the push-type charging interconnection structure (i.e., the speaker body is separated from the vehicle dashboard), the wire fixing plate body of the push-type charging interconnection structure, due to the pulling force of the elastic element, will rotate downward and away from the speaker body. Therefore, when the speaker body is engaged, the charging port of the power cord can be inserted into the speaker body to provide power. When the speaker body is removed, the charging port of the power cord can be automatically disconnected and retracted into the vehicle. This retraction not only avoids the risk of the charging port being exposed and contacting other components or getting damaged but also eliminates a safety issue while enhancing the aesthetic effect. Therefore, the safety, convenience of use, and aesthetics of the wiring connected to the speaker body during fitting or separation are all improved.

It should be noted that in this document, the terms “including,” “comprising,” or any other variation thereof are intended to encompass non-exclusive inclusion, such that a process, method, article, or apparatus that includes a list of elements is not limited to those elements but may also include elements not expressly listed, or additional elements inherent to such process, method, article, or apparatus. Without further limitation, an element defined by the phrase “comprising a . . . ” does not exclude the presence of additional identical elements in the process, method, article, or apparatus that comprises the element.

The above description, in conjunction with the accompanying drawings, provides a detailed description of embodiments of the present invention. However, the present invention is not limited to the specific embodiments described above, which are merely illustrative and not restrictive. Those skilled in the art, in light of the teachings of the present invention, can make numerous modifications without departing from the spirit and scope of the invention as defined by the claims. All such modifications are within the scope of the present invention.

What is claimed is:

1. A push-type charging interconnection structure, comprising:
a base;
an abutting block disposed movably forward and backward on a front side of the base;
a wire fixing plate body disposed rotatably at a bottom of the base; and
an elastic element one end of the elastic element being fixed to the base and an other end of the elastic element being fixed to the wire fixing plate body.

2. The push-type charging interconnection structure as claimed in claim 1, wherein the base comprises:
a groove;
a hole penetrating through the groove from a front side of the groove to a rear side of the groove;
a sheet body located adjacent a top of the hole and extending forward from a front side of the groove and away from the groove;
a fixing element extending from a bottom surface of the sheet body and away from the sheet body; and
a bottom plate extending downward from a bottom of the groove.

3. The push-type charging interconnection structure as claimed in claim 2, wherein the fixing element comprises:
a fixing main body extending from the bottom surface of the sheet body and away from the sheet body; and
a stopper set parallel to the sheet body, the stopper being located at a bottom of the fixing element.

4. The push-type charging interconnection structure as claimed in claim 3, wherein the abutting block comprises:
a plate body;
a convex element respectively extending from a top and a bottom of the plate body and away from the plate body, the convex element extending forward and bending outward and extending arcuately, and the convex element bending inward and extending in a direction of an extension line at two ends of the plate body;
a combining element protruding from a rear side of the convex element in a direction away from the convex element; and
an abutting element protruding from the rear side of the convex element adjacent the bottom of the plate body in the direction away from the convex element.

5. The push-type charging interconnection structure as claimed in claim 4, wherein the wire fixing plate body comprises:
a bending part;
a through hole penetrating from a front side of the bending part to a rear side of the bending part, the through hole being located adjacent a top of the bending part;
an arc part extending downward obliquely from a bottom of the bending part and extending forward arcuately and away from the bottom of the bending part; and
a cylinder combining element located on an outer side adjacent the bottom of the bending part, the cylinder combining element extending outward from the outer side of the bending part.

6. The push-type charging interconnection structure as claimed in claim 5, wherein the through hole comprises:
a first hole extending from a top of the through hole toward the bottom of the groove; and
a second hole extending from a bottom of the first hole toward the bottom of the groove and flaring toward two opposite side walls of the groove.

7. The push-type charging interconnection structure as claimed in claim 6, wherein the elastic element passes through the first hole and the abutting element passes through the second hole.

8. The push-type charging interconnection structure as claimed in claim 7, wherein the fixing element extends gradually inward from the bottom surface of the sheet body in a direction away from the sheet body.

9. The push-type charging interconnection structure as claimed in claim 8, wherein the bottom plate comprises:
a notch recessed from a portion of a bottom of the bottom plate in the direction of the groove; and
a first semicircular groove located on a rear side of the bottom plate, the first semicircular groove being located on two opposite sides of the notch and extending outward in a direction away from the notch.

10. The push-type charging interconnection structure as claimed in claim 9, wherein the push-type charging interconnection structure further comprises a fixing part located on the bottom plate.

11. The push-type charging interconnection structure as claimed in claim 10, wherein the fixing part comprises:
a fixing plate body;
a second semicircular groove recessed from a front side of the fixing plate body to a rear side of the fixing plate body, two ends of the second semicircular groove being respectively located on two side surfaces of the fixing plate body;
a position limiting sheet body extending from one end of the second semicircular groove toward the front side of the fixing plate body; and
a fixing hole located adjacent a top and a bottom of the fixing plate body.

12. A push-type charging interconnection system for a detachable speaker, comprising:
a speaker body; and
a push-type charging interconnection structure as claimed in claim 11,
wherein the speaker body is movably located on a front side of the push-type charging interconnection structure,
wherein, when the speaker body moves toward the push-type charging interconnection structure, the wire fixing plate body of the push-type charging interconnection structure is driven to rotate toward the speaker body,
wherein, when the speaker body moves away from the push-type charging interconnection structure, the wire fixing plate body of the push-type charging interconnection structure is pulled by the elastic element to rotate downward away from the speaker body.

13. The push-type charging interconnection system for a detachable speaker as claimed in claim 12, wherein, when the speaker body moves toward the push-type charging interconnection structure, the wire fixing plate body drives the charging element such that the charging element engages with the charging interface inside the speaker body.
